(19) United States
(12) Patent Application Publication
(10) Pub. No.: US 2013/0175358 A1
(43) Pub. Date: Jul. 11, 2013

(54) ROTARY BLADE AND ATOMIZER COMPRISING THE SAME

(71) Applicant: Chung-Ming LEE, Taichung City (TW)

(72) Inventor: Chung-Ming LEE, Taichung City (TW)

(21) Appl. No.: 13/483,483

(22) Filed: May 30, 2012

(30) Foreign Application Priority Data
Jan. 6, 2012 (TW) 101200352

(51) Int. Cl. B05B 3/02

(52) U.S. Cl. 239/214

(57) ABSTRACT

An atomizer includes a shell, a rotary blade, a rotary device, and an air blower. The shell contains water. The rotary device is disposed in the shell firmly. The rotary blade is disposed on the rotary device used for driving the rotary blade to rotate. When the rotary blade is rotating, the water in the shell is thrown and sprayed by the rotary blade and strikes against the baffle surrounding the rotary blade. The present invention can produce droplets called water mist carried the anions. Thereafter the air blower drives air to flow to outside of the shell with the water mist. The water mist shall distribute in the ambient environment.

### BACKGROUND OF THE INVENTION

1. Field of the Invention

The present invention relates to an atomizing apparatus for producing by atomization a fine water mist or fog of aerosol particles of a size capable being suspended in air.

2. Description of the Prior Art

Conventional atomizing apparatuses include a high-frequency shaker generating high-frequency vibration to vibrate the water around the shaker, so that the water produces droplets. Further, the droplets are blew up and suspended in the ambient environment by an electrical fan or the like. Wherein users can add some essential oil into water. Whereby the droplets can kill germs, remove odor, freshen up, or other functions. Many similar apparatuses are disclosed, such as TW M281635 and TW M280812.

In these apparatuses, some patents or types mention about they can produce anions by vibrating and atomizing the water. However, the effect of producing anions with the manner is still not very well.

The present invention is, therefore, arisen to obviate or at least mitigate the above mentioned disadvantages.

### SUMMARY OF THE INVENTION

The main object of the present invention is to provide an atomizing apparatus which produces water mist carrying anion with other manners.

To achieve the above and other objects, an atomizer of the present invention includes a shell, a rotary blade, a rotary device, and an air blower.

The shell is formed with a receiving space for storaging water therein. The shell is formed with an air intake channel and an exhaust channel. The air intake channel and the exhaust channel communicate to the receiving space respectively. The shell has an annular baffle.

The rotary blade has a rotation axle and a plate. The plate extends from the rotation axle radially. The plate has an outer periphery tortuously formed with at least a radial recess. One end of the rotation axle extends from the plate axially and narrows down gradually.

The rotary device is disposed in the shell firmly. The rotary blade is disposed on the rotary device used for driving the rotary blade to rotate. The rotary blade is located in the receiving space, and the baffle surrounds the rotary blade. A gradual-narrowing end of the rotation axle of the rotary blade is used for inserting to the water in the receiving space, so that the water in the receiving space is sprayed radially by the rotation axle of the rotary blade and the surface of the plate of the rotary blade and strikes against the baffle.

The air blower is disposed in the shell firmly. The air blower is used for driving air via the air intake channel into the receiving space and then via the exhaust channel away from the receiving space.

Whereby the atomizer of the present invention can throw and spray the water with the rotary device 4 and the rotary blade 5. The water further strikes against the baffle of the shell and produce droplets carried the anions. That is, present invention can produce water mist carried the anions. In other words, the present invention is good at atomizing the water.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing an atomizer;

FIG. 2 is a breakdown drawing showing an atomizer;

FIG. 3 is a partial breakdown drawing showing an atomizer;

FIG. 4 is a cross-section view showing an atomizer;

FIG. 5 is a side cross-section view showing an atomizer;

FIG. 6 is a stereogram showing a rotary blade;

FIG. 7 is a diagram showing a rotary blade to be installed in a predetermined position;

FIG. 8 is a cross-section showing a droplets straining device;

### DETAILED DESCRIPTION OF THE PREFERRED EMBODIMENTS

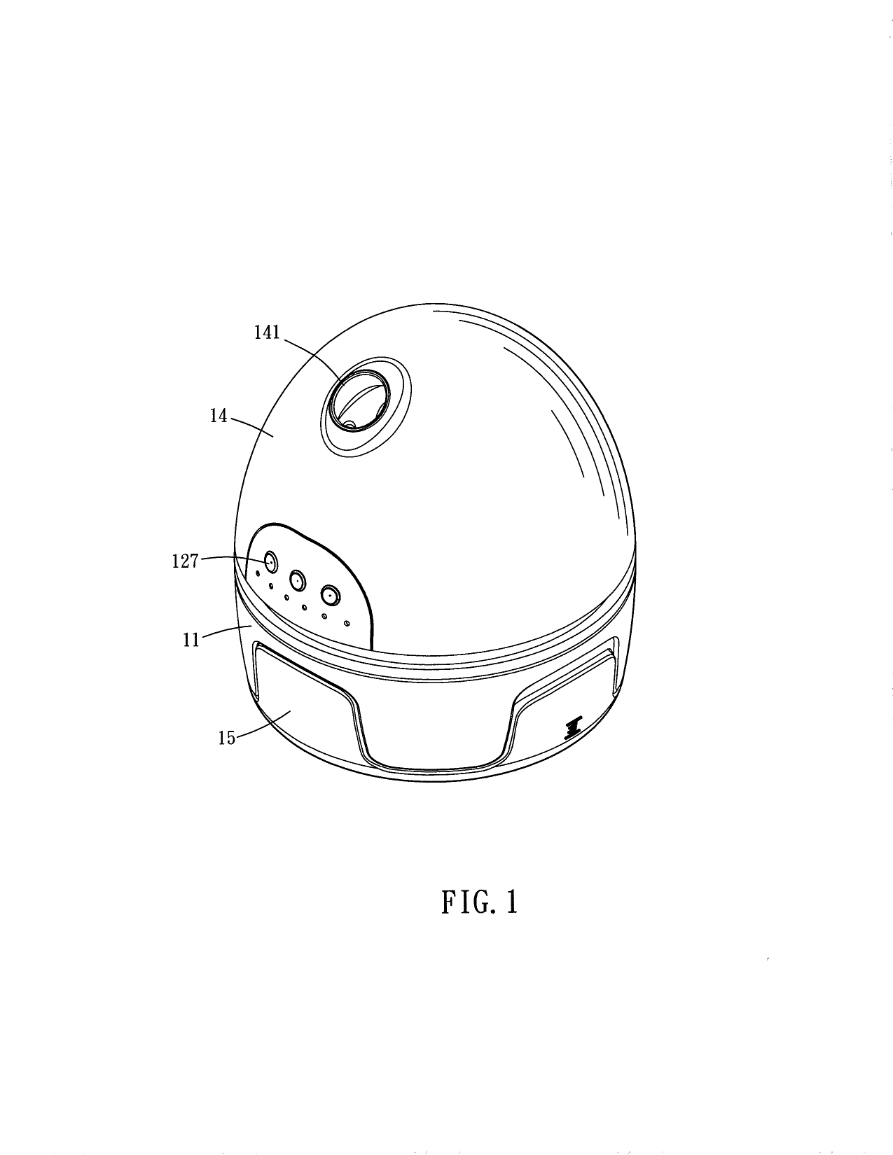

Please refer to FIG. 1 to FIG. 5, the atomizer comprises a shell, an air blower 2, an atomizing device 3, a rotary device 4, a rotary blade 5, and a droplets straining device 6.

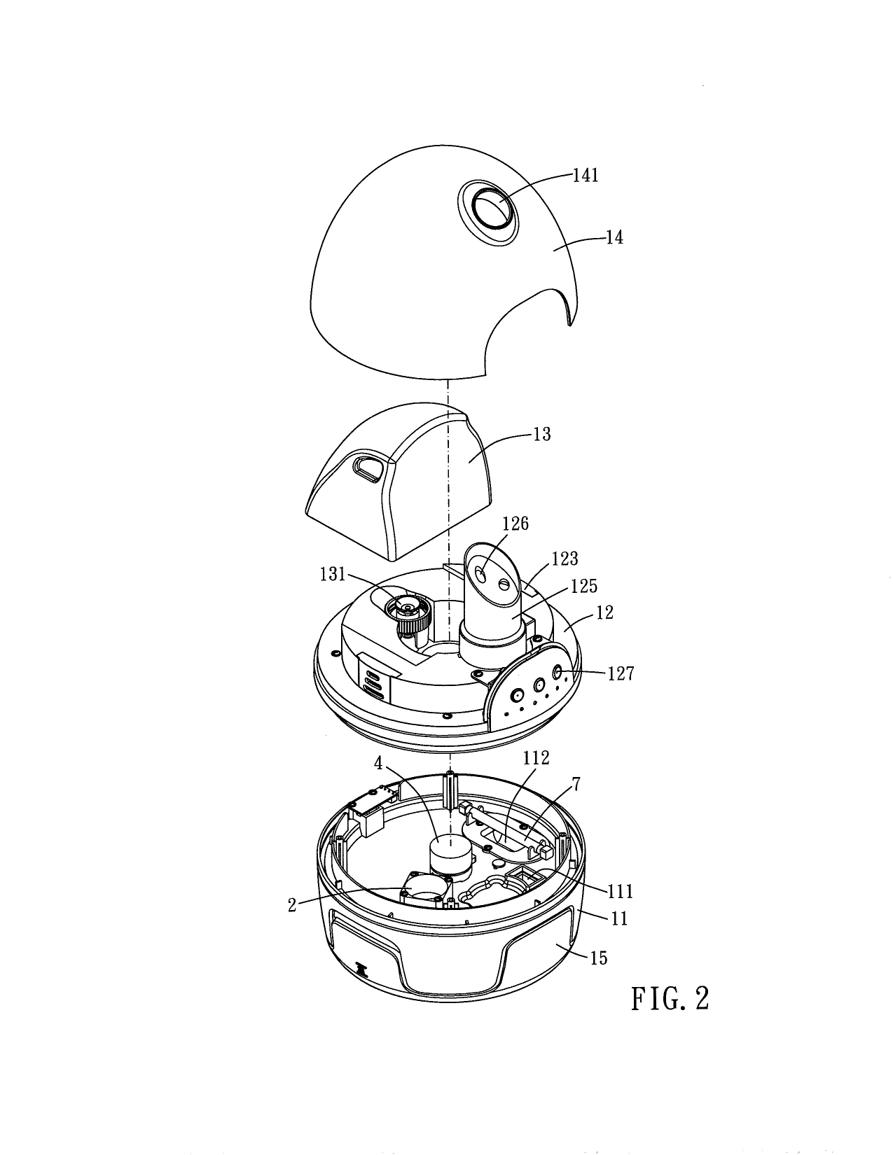

Please refer to FIG. 2, the shell includes a base 11, a laminate 12, a tank 13, and an outer housing 14. The shell further has a bottom housing 15 under the base 11. After assembling the bottom housing 15, the base 11, the laminate 12, the tank 13, and the outer housing 14 in turn, the shell to be completely installed, and the shell is formed with a receiving space therein. The receiving space further is divided into several rooms by the base 11, the laminate 12, and the tank 13.

The bottom housing 15 is detachably assembled to the base 11 and is used for containing water in the room between the bottom housing 15 and the base 11. Wherein the amount of water preferably is less than or equal to one half of the room, so that the room still has some dead space.

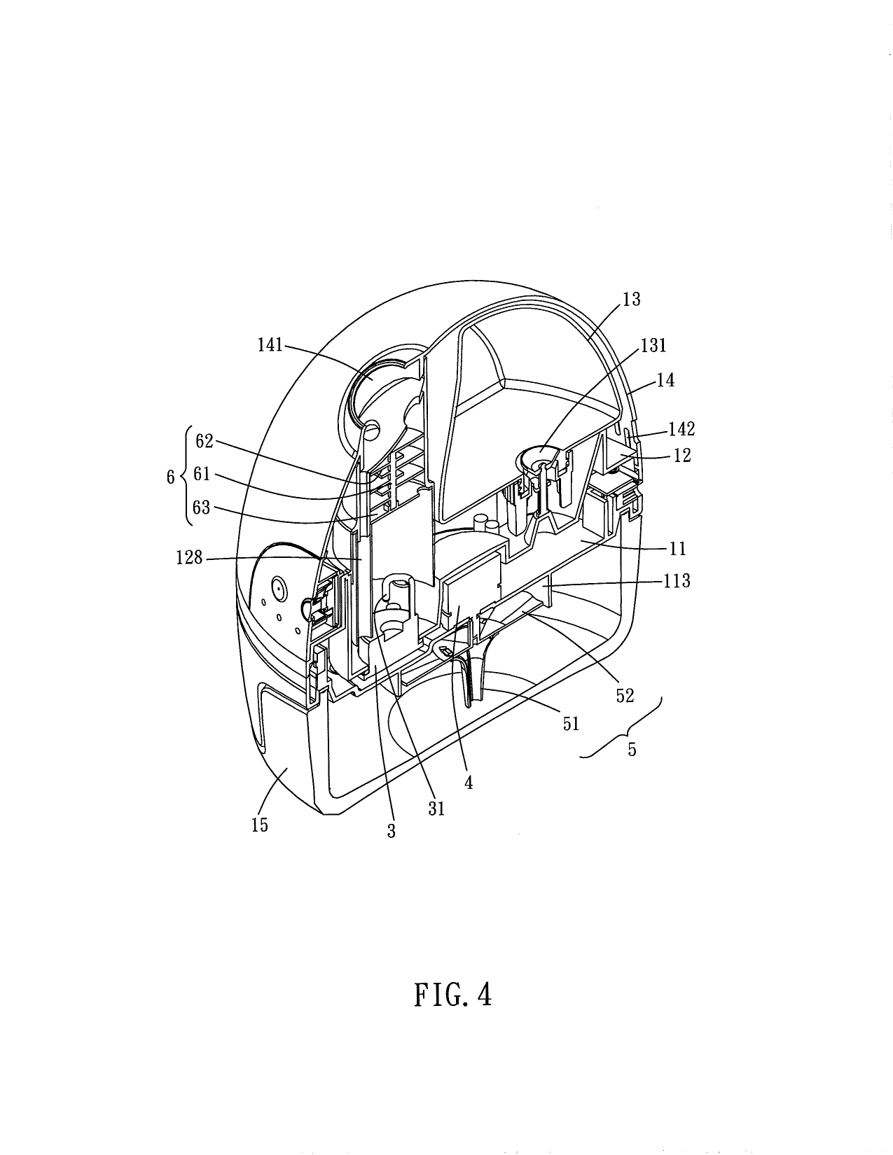

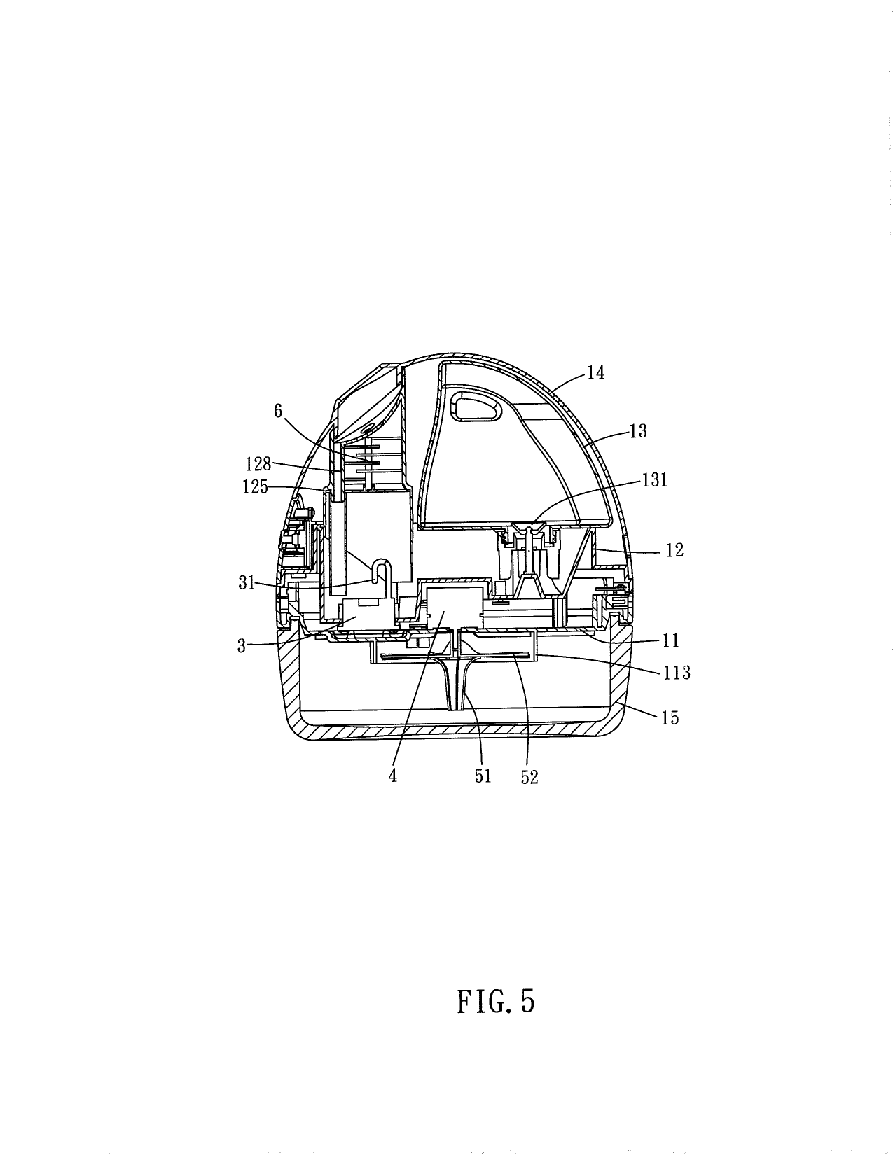

The base 11 is formed with two openings 111 and a transparent window 112. And the air blower 2, the rotary device 4, and an ultraviolet lamp 7 are disposed in the base 11 firmly. Wherein the air blower 2 corresponds to one of the openings, the other opening 111 keeps opening freely. The ultraviolet lamp 7 corresponds to the transparent window 112, so that the ultraviolet lamp towards the room between the base 11 and the bottom housing 15 emits ultraviolet ray through the transparent window 112 into the room. Please refer to FIG. 4 and FIG. 5, the base has an annular baffle 113 protruding from the base 11 and located between the base 11 and the bottom housing 15.

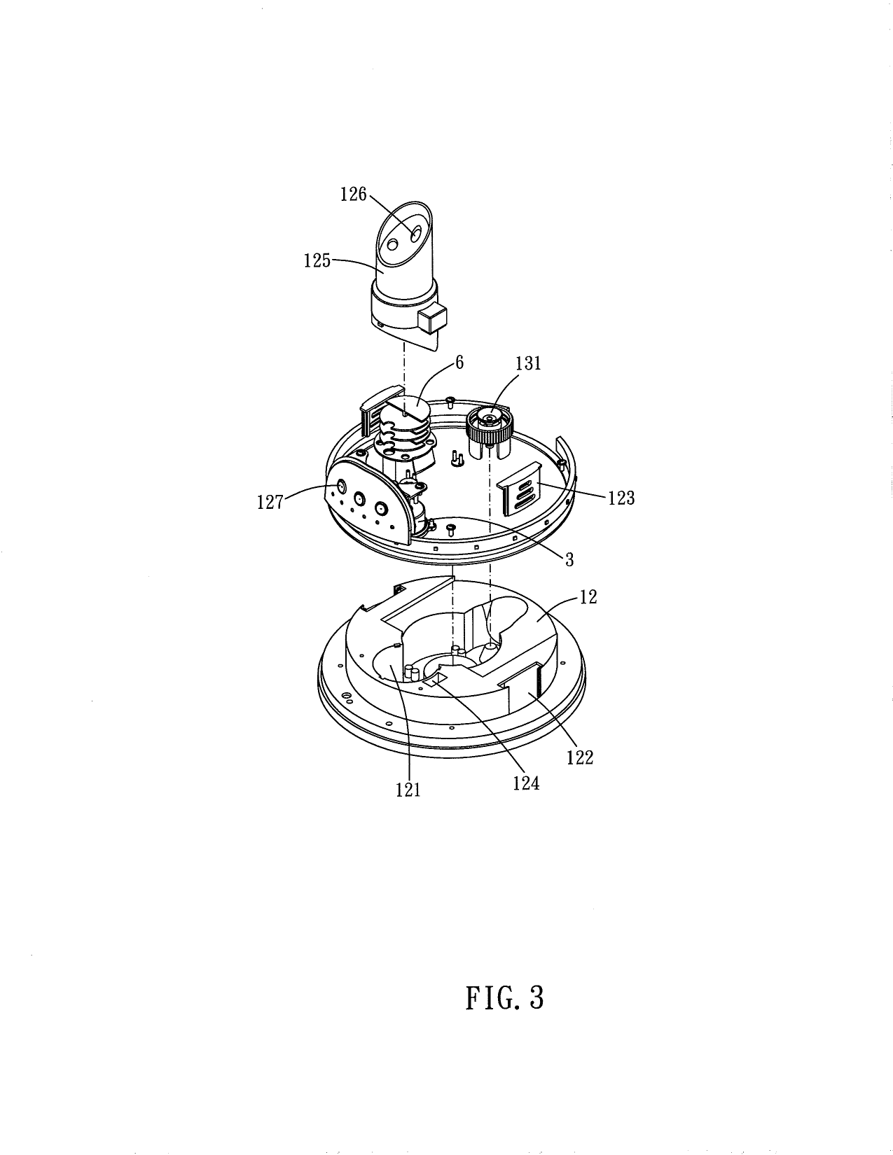

Please refer to FIG. 2 to FIG. 4, the laminate 12 is disposed on the base 11. The atomizing device 3 is disposed on the laminate 12 firmly. As shown in FIG. 3, the surface of the laminate 12 is formed with a concave groove 121. The atomizing device is located the lower part of the concave groove 121, so that the concave groove 121 may contain water. The water can flow towards the lower part of the concave groove 121 into the atomizing device 3 spontaneously. The laminate 12 is formed with an opening hole 122 communicating a room of an upper side of the laminate 12 to a room of a lower side of the laminate 12. Preferably, a filter plate 123 or other similar filtration devices drawably disposed in the opening hole 122 are used for filtrating the dust carried by air which flows through the opening hole 122. The laminate 12 is formed with an opening 124 communicating with the open-freely opening 111 of the base. In this way, the air from the room between the base 11 and the bottom housing 15 flows through the opening 111 of the base 11 and the opening 124 of the laminate into the upper side of the laminate 12. The laminate 12 has an exhaust cylinder 125 thereon. A bottom of the exhaust cylinder 125 covers upon the atomizing device 3 and the opening 124 of the laminate 12. A top of the exhaust cylinder 125 is formed with a pore 126, so that the exhaust cylinder 125 is formed with an exhaust channel. The exhaust channel has a tubular space. The laminate 12 further has a controlling button 127 or a panel used for controlling each element of the present invention on and off or controlling each element's working efficiency.

The tank 13 disposed on the laminate 12 includes a valve 131 receiving in the concave groove 121. The tank 13 contains water. The water can flow through the valve 131 into the concave groove 121 of the laminate. Wherein the valve 131 is able to be turned on and off as the amount of water in the concave groove 121, so as to avoid too much water from the tank 13 filling into the concave groove 121 and overflowing the concave groove 121.

The outer housing 14 disposed on the laminate 12 is formed with an opening 141 corresponding to the pore 126 of the top of the exhaust cylinder 125, so that the air of the receiving space of the shell exhausts outwardly via the exhaust channel and the opening 141. Please refer to FIG. 4, the outer housing 14 is formed with several air inlets 142 called air intake channels. The air inlets 142 directly communicate with the room between the outer housing 14 and the laminate 12, so that the outside air may flow through the air inlets 142 into the receiving space of the shell.

Please refer to FIG. 2 to FIG. 4, the air blower 2 disposed in the shell firmly is used for driving air via the air intake channel into the receiving space and then via the exhaust channel away from the receiving space. More specifically, the air blower 2 is disposed in the base 11. When the air blower is turned on, the air between the base 11 and the laminate 12 would be sent into the room between the base 11 and the bottom housing 15. At the present time, the outside air may flow through the air inlets 142 of the outer housing, the room between the outer housing 14 and the laminate 12, and the opening 122 of the laminate 12 into the room between the base 11 and the laminate 12. The air in the room between the base 11 and the bottom housing 15 is pushed and flows through the opening 111 of the base 11 and the opening 124 of the laminate 12, which correspond to each other, into the exhaust cylinder 125 and then via the exhaust channel to outside of the shell.

The atomizing device 3 is disposed on the laminate 12. When the atomizing device 3 is turned on, it would generate high-frequency vibration to vibrate and atomize the water contacting the atomizing device 3 into droplets. The droplets would suspend upwardly in the air so the exhaust cylinder 125 is full of droplets. When the air exhausts to outside of the shell outwardly, the droplets would flow out to outside of the shell with the air. Wherein the atomizing device 3 further has a sensor 31 extending upwardly. The sensor 31 is used for determining the water level. When the atomizing device 3 is immersed in the water and the water level rises up to a predetermined level of the atomizing device 3, the sensor 31 would turn off the atomizing device 3.

The rotary device 4 disposed in the base 11 is used for providing a rotary power. More definitely, the rotary device 4 is a motor or the like and includes gear assembly or other similar rotational speed adjustable mechanisms.

The rotary blade 5 is disposed on the rotary device 4 used for driving the rotary blade 5 to rotate. Please refer to FIG. 4 to FIG. 7, the rotary blade 5 has a rotation axle 51 and a plate 52. The plate 52 extends from the rotation axle 51 radially. The plate 52 has an outer periphery tortuously formed with one or more radial recesses 53. In this embodiment, the outer periphery is formed with five radial recesses 53. The radial recesses 53 surround the rotation axle 51 and arrange on the outer periphery circularly. Preferably, the radial recesses 53 arrange on the outer periphery circularly and equidistantly, so that the plate 52 is formed with plural wings. Each wing is located between two adjacent radial recesses. The plate 52 is formed with a plurality of peaks and a plurality of valleys. The peaks and the valleys extend radially and arrange circularly, so that the plate 52 is axially curved and formed in a wave shape. A top of the rotation axle 51 is installed on the rotary device 4, and a bottom of the rotation axle 51 extends from the plate 52 axially and narrows down gradually. The bottom of the rotation axle 51 inserts to the water contained in the bottom housing 15. Also, the bottom of the rotation axle 51 is hollow so as to lose its weight. The rotary blade 5 is located in the room between the base 11 and the bottom housing 15. And the baffle 113 of the base surrounds the rotary blade 5. More specifically, the baffle 113 surrounds the plate 52.

The water contained in the bottom housing 15 is thrown and sprayed by said rotary device 4 and rotary blade 5. And then the water strikes against the baffle 113. Thereafter, the water mist or the droplets are generated and carry the anions. When the rotary device 4 drives the rotary blade 5 to rotate, due to the water contained in the bottom housing 15, especially in contact with the bottom of the rotation axle 51, is influenced by the effect of centrifugal force and its adhesion force, so that the water is moved along the surface of the rotation axle 51 to the surface of the plate 52, and further is sprayed radially by the surface of the plate 52 and strikes against the baffle 113. The water contained in the bottom housing 15 is stricken continuously and then falls down like a waterfall. Afterwards the present invention produces water mist or droplets carried the anions in the room between the base 11 and the bottom housing 15. The air driven by the air blower 2 carries the water mist or the droplets to the exhaust cylinder 125, and further flows to outside of the shell together.

Please refer to FIG. 3 to FIG. 5, the droplets straining device 6 comprises a rod 61 and a division plate assembly. The division plate assembly extends from the rod 61 radially. The droplets straining device 6 is disposed in the exhaust cylinder 125 firmly. Preferably, the droplets straining device 6 can assemble with and detach from the exhaust cylinder 125 so the droplets straining device 6 is received in the tubular space of the exhaust cylinder 125. An outer periphery of the division plate assembly away from the rod 61 abuts a periphery of the tubular space and defines the tubular space into a gas channel, so that the air flowed through the exhaust cylinder 125 or the exhaust channel have to flow through the gas channel of the droplets straining device 6. Wherein the gas channel is curved in shape and extends non-linearly. Thereby an extending length of the gas channel longer than a length of the tubular space.

More clearly, please FIG. 4 and FIG. 8, in this embodiment, the division plate assembly of the droplets straining device 6 comprises a plurality of division plates 62 and 62′. The division plates 62 and 62′ respectively extend from the rod 61 radially so that the tubular space, which is the droplets straining device 6 therein, is divided into plural compartments. One side of each of the division plates 62 and 62′ is formed with an opening. Any two adjacent compartments are communicated with each other by the opening therebetween. Wherein for curving the gas channel, the positions of the openings of two adjacent the division plates 62 and 62′ are staggered to each other. In other words, the openings of any two adjacent division plates 62 and 62′ do not overlap and intersect with each other when looking at the division plate assembly from an orientation parallel to the rod 61. Preferably, the openings of any two adjacent division plates 62 and 62′ are further away from each other, so that the air is blocked by the division plates 62 and 62′ and the positions of the openings of the division plates 62 and 62′. The air cannot flow through the openings of two adjacent division plates 62 and 62′ linearly. In this embodiment, the opening of each of division plates 62 and 62′ is semicircular in shape. Wherein due to the division plates 62 and 62′ have to be disposed on the rod 61 and stagger to adjacent division plates for blocking the openings, the specific figure of each opening of the division plates 62 and 62′ is bow-shaped and smaller than a semicircle.

The droplets straining device 6 comprises a bottom plate 63 extending from a bottom of the rod radially. An outer periphery of the bottom plate 63 abuts the periphery of the tubular space. The bottom plate 63 is formed with plural openings 631 communicating between the space under the bottom plate 63 and the gas channel divided by the division plate assembly. In addition, please refer to FIG. 4, in this embodiment, the exhaust cylinder has a tube 128. The condensed water on the top of the exhaust cylinder 125 flows through the tube 128 into the concave groove 121 of the laminate 12 to recycle the condensed water. The droplets straining device 6 is formed with plural concave holes 621 and 632 on some division plates 62 and the bottom plate 63. The concave holes 621 and 632 correspond to the tube 128.

The use of said device, please refer to FIG. 2 to FIG. 5, the present invention provides users to contain water with the tank 13 and the bottom housing 15. Users can add appropriate amount of addition agent, such as aromatic essential oil. The appropriate amount of water in the tank 13 flows through the valve 131 to the concave groove 121 of the laminate 12 and is in contact with the atomizing device 3. After users turn on the present invention, the rotary device 4 would drive the rotary blade to rotate. The water contained in the bottom housing 15 strikes against the baffle 113 of the base and atomizes into the droplets carried the anions. The water in the concave groove 121 atomizes into droplets with high-frequency vibration generated by the atomizing device 3. Afterwards the air blower 2 drives the air to move. The air would carry the droplets to the exhaust cylinder 125 and further flow through the gas channel of the droplets straining device 6 to outside of the shell.

Wherein the present invention can throw and spray the water contained in the bottom housing 15 with the rotary device 4 and the rotary blade 5, so as to produce the droplets carried the anions. In other words, the present invention is good at atomizing the water. Wherein, because the atomizing device is able to produce droplets as well, in other embodiments of the present invention the atomizing device 3 can be removed, the embodiments can still produce droplets with the rotary devices 4 and the rotary blades 5. In this condition, the present invention without the atomizing device 3 can still produce droplets. The rotary blade 5 of the present invention has one or more radial recesses.

Users can conveniently detach the rotary blade 5 for cleaning or repairing. Please refer to FIG. 7, because the rotary blade 5 has the radial recesses 53, when users would like to detach the rotary blade 5, they shall stretch their fingers to the radial recesses 53, thereafter the rotary blade 5 is removed from the present invention and take it down. That is, it can avoid the rotary blade 5 blocking by the baffle 113 and detaching difficulty.

Secondly, because the rotary blade 5 has the radial recesses 53, the rotary blade 5 is lighter than the conventional rotary blade. Whereby the present invention can reduce weight. Or reducing the burden of the rotary device 4 when it drives the rotary blade to rotate.

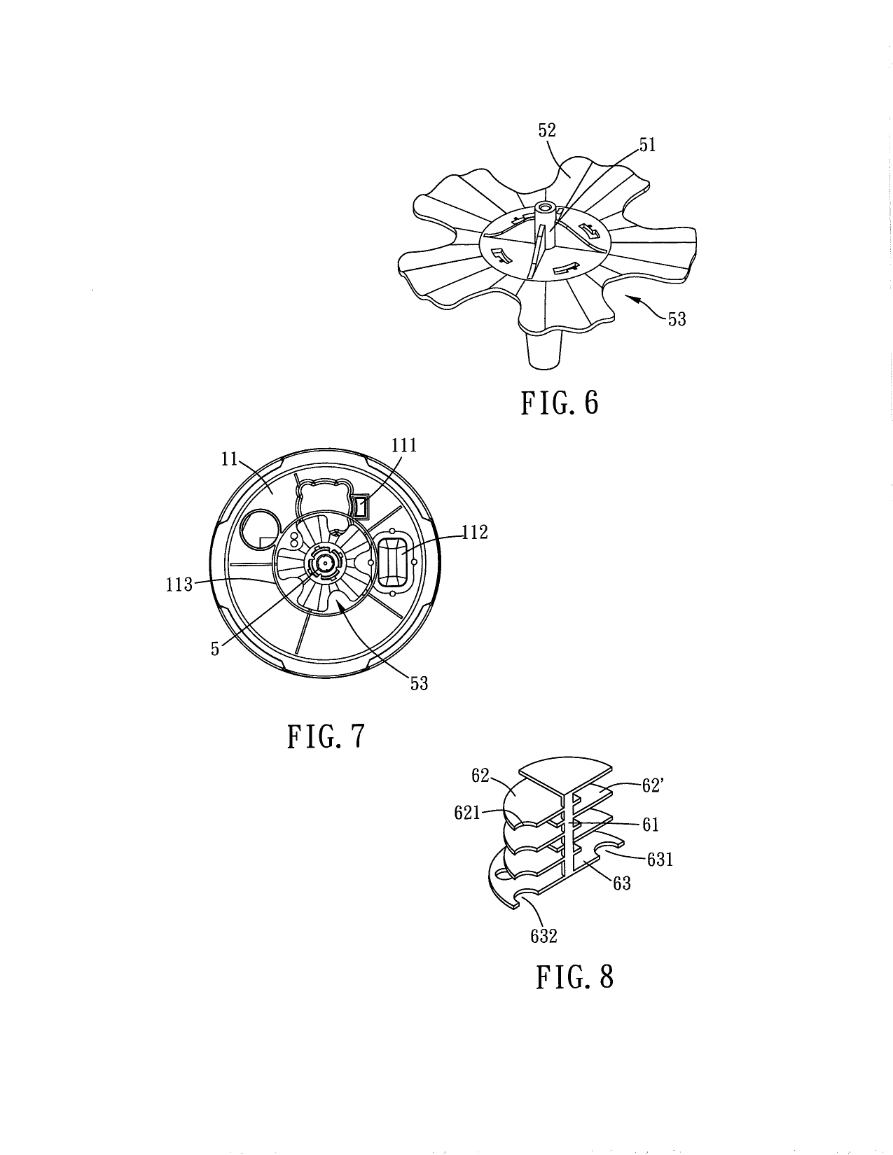

The plate 52 of the rotary blade of the present invention can curve to wave-shaped, as shown in FIG. 6, so that the plate 52 increases its surface area. The water thrown and sprayed by the surface of the plate 52 is finer and atomizes to the drops smaller. Whereby the present invention can enhance the atomizing effect.

What is claimed is:

1. A rotary blade, adapted to be installed in an atomizer, the rotary blade having a rotation axle and a plate, the plate extending from the rotation axle radially, the plate having an outer periphery tortuously formed with at least a radial recess.

2. The rotary blade of claim 1, wherein the outer periphery is formed with a plurality of radial recesses, the radial recesses surround the rotation axle and arrange on the outer periphery circularly, so that the plate is formed with plural wings, each wing is located between two adjacent radial recesses.

3. The rotary blade of claim 1, wherein the plate is formed with a plurality of peaks and a plurality of valleys, the peaks and the valleys extend radially and arrange circularly, so that the plate is axially curved and formed in a wave shape.

4. The rotary blade of claim 2, wherein the plate is formed with a plurality of peaks and a plurality of valleys, the peaks and the valleys extend radially and arrange circularly, so that the plate is axially curved and formed in a wave shape.

5. The rotary blade of claim 1, wherein one end of the rotation axle extends from the plate axially and narrows down gradually.

6. An atomizer, comprising the rotary blade of claim 1, the atomizer further comprising:
a shell, formed with a receiving space for storaging water therein, the shell being formed with an air intake channel and an exhaust channel, the air intake channel and the exhaust channel communicating to the receiving space respectively, the shell having an annular baffle;
a rotary device, disposed in the shell firmly, the rotary blade being disposed on the rotary device used for driving the rotary blade to rotate, the rotary blade being located in the receiving space, and the baffle surrounding the rotary blade, so that the water in the receiving space being sprayed radially by the surface of the plate of the rotary blade and striking against the baffle;
an air blower, disposed in the shell firmly, the air blower being used for driving air via the air intake channel into the receiving space and then via the exhaust channel away from the receiving space.

7. The atomizer of claim 6, further comprising an atomizing device disposed in the shell firmly and located in the receiving space, the atomizing device being capable of generating vibration to atomize the water in the receiving space.

8. An atomizer, comprising the rotary blade of claim 5, the atomizer further comprising:
a shell, formed with a receiving space for storaging water therein, the shell being formed with an air intake channel and an exhaust channel, the air intake channel and the exhaust channel communicating to the receiving space respectively, the shell having an annular baffle;
a rotary device, disposed in the shell firmly, the rotary blade being disposed on the rotary device used for driving the rotary blade to rotate, the rotary blade being located in the receiving space, and the baffle surrounding the rotary blade, a gradual-narrowing end of the rotation axle of the rotary blade being used for inserting to the water in the receiving space, so that the water in the receiving space being sprayed radially by the rotation axle of the rotary blade and the surface of the plate of the rotary blade and striking against the baffle;
an air blower, disposed in the shell firmly, the air blower being used for driving air via the air intake channel into the receiving space and then via the exhaust channel away from the receiving space.

9. The atomizer of claim 8, further comprising an atomizing device disposed in the shell firmly and located in the receiving space, the atomizing device being capable of generating vibration to atomize the water in the receiving space.
